(19) United States
(12) Patent Application Publication
(10) Pub. No.: US 2009/0269514 A1
(43) Pub. Date: Oct. 29, 2009

(54) Polarizing Plate

(75) Inventors: Kaori Seki, Tochigi (JP); Tadashi Akamatsu, Tochigi (JP); Zemin Shi, Tochigi (JP)

Correspondence Address: OLIFF & BERRIDGE, PLC, P.O. BOX 320850, ALEXANDRIA, VA, 22320-4850, US

(73) Assignee: SONY CHEMICAL & INFORMATION DEVICE CORPORATION, Tokyo (JP)

(21) Appl. No.: 11/887,725

(22) PCT Filed: Apr. 14, 2005
(86) PCT No.: PCT/JP2005/007205

§ 371 Date: Oct. 19, 2007

(51) Int. Cl. C09K 19/52

(52) U.S. Cl. 428/1.31

(57) ABSTRACT

A polarizing plate is provided in which adhesion properties between a polarizer and a protection film are improved and in which the optical properties of the polarizer are stable under the influence of moisture and the like. Specifically, in polarizing plates 4 and 12, protection films 3 and 11 are formed on at least one side of polarizers 2 and 10, respectively, by curing an energy ray-curable composition. The energy ray-curable composition contains (1) an energy ray-polymerizable compound having a bridged hydrocarbon group, a bisphenol group, a neopentyl glycol group, a trimethylolpropane group, or a pentaerythritol group and (2) a hydrolysate of a silane-based coupling agent. At least one of the polarizing plates 4 and 12 is provided on at least one side of a liquid crystal panel 1, whereby a liquid crystal device 9 is constituted.

### TECHNICAL FIELD

The present invention relates to a polarizing plate.

### BACKGROUND ART

Polarizing plates have been used in optical devices including liquid crystal display devices, organic EL display devices, eyeglasses, and the like. Conventionally, as such polarizing plates, there have generally been used polarizing plates in which a uniaxially stretched film made of a polyvinyl alcohol-based resin and stained with iodine is used as a polarizer and in which a protection film is applied to both sides of the polarizer with an adhesive in order to improve their strength, water resistance, moisture resistance, and the like.

In these polarizing plates, a cellulose acetate-based resin film (a TAC film) which is excellent in optical transparency is used as the protection film, and a hydrophilic adhesive is used in view of the fact that both the polarizer and the protection film are hydrophilic.

However, in such polarizing plates, a reduction in performance is more likely to occur at high temperature and high humidity. This may be because of the following reason. In a uniaxially stretched film made of a polyvinyl alcohol-based resin, its polarizing ability is caused by color development of polyiodine ions (such as I₃⁻ and I₅⁻). When moisture (water vapor) is supplied to a polarizer, polyiodine is decomposed to generate iodine ions (I⁻), and thus the color development caused by the polyiodine ions is reduced. Hence, the light transmittance of the polarizer is increased, and the polarizing ability of the polarizer is gradually lost. This phenomenon becomes more remarkable in a high temperature environment.

Moreover, in the abovementioned polarizing plates, since all the polarizer, the adhesive, and the protection film are hydrophilic, deformation or the like is more likely to occur at high temperature and high humidity.

Therefore, the protection film of the polarizing plates is required to protect the polarizer from the influence of outside moisture or the like, and thus an attempt has been made to form a protection film having a thickness of 80 μm or more. However, when the thickness of a protection film is 80 μm or more, it is not possible to meet the requirement associated with the reduction in thickness of recent optical devices, i.e., the requirement of reducing the thickness of a protection film to 40 μm or less.

In addition to the above, in order to improve the moisture resistance, heat resistance, and the like of polarizing plates, the following, for example, have been proposed. A polarizer is coated with a photocurable composition containing an ethylene-acrylate monomer-maleic anhydride copolymer and a silane-based coupling agent, and thereafter the photocurable composition is cured by applying ultraviolet rays (Patent Document 1). A blended material of (i) silicate oligomers which are hydrolytic condensates of tetraalkoxysilane, (ii) an acrylic-based resin, and (iii) a silane-based coupling agent is applied to a polarizer and is heated and cured (Patent Document 2). In these manners, a reduction in performance at high temperature and high humidity can be prevented, and the lamination of the abovementioned conventional protection film made of a cellulose acetate-based resin can be omitted, whereby the thickness of the polarizing plates themselves can be reduced.

However, hydrophobic acrylic-based resins often exhibit insufficient adhesion to a polarizer. Therefore, the following, for example, has been proposed. Specifically, an undercoat layer is formed on a polarizer, and a curable resin composition is applied thereon and is cured by ultraviolet radiation (Patent Document 3).

[Patent Document 1] Japanese Patent Application Laid-Open No. Hei 9-159828.

[Patent Document 2] Japanese Patent Application Laid-Open No. Hei 10-138382.

[Patent Document 3] Japanese Patent Application Laid-Open No. Hei 11-295522.

### DISCLOSURE OF THE INVENTION

### Problems to be Solved by the Invention

However, in conventional polarizing plates, the adhesion properties of a protection film are still insufficient. Furthermore, in the mode in which an undercoat layer is provided, problems exist in which the number of steps becomes large and in which there is a fear of the formation of iodine ions in the used solvent system.

In view of the above, it is an object of the present invention to provide a polarizing plate in which adhesion properties between a polarizer and a protection film are improved and in which the optical properties of the polarizer are stable under the influence of moisture and the like.

### Means for Solving the Problems

The present inventors have found that the above object can be achieved by forming a protection film by using a curable composition composed of a specific polymerizable compound and a hydrolysate of a silane-based coupling agent.

Accordingly, the present invention provides a polarizing plate comprising a polarizer and a protection film formed on at least one side of the polarizer by curing an energy ray-curable composition, wherein the energy ray-curable composition contains (1) an energy ray-polymerizable compound having a bridged hydrocarbon group, a bisphenol group, a neopentyl glycol group, a trimethylolpropane group, or a pentaerythritol group and (2) a hydrolysate of a silane-based coupling agent. In a particularly preferred aspect, a treated solution prepared by hydrolyzing trialkoxysilane or dialkoxysilane with aqueous boric acid is used as the hydrolysate of the silane-based coupling agent.

Furthermore, the present invention provides a liquid crystal display device comprising a liquid crystal panel and the polarizing plate provided on at least one side of the liquid crystal panel.

### EFFECTS OF THE INVENTION

In the polarizing plate of the present invention, a protection film is provided on a polarizer. The protection film is formed by using a curable composition composed of a specific polymerizable compound and a hydrolysate of a silane-based coupling agent. Thus, even when the protection film is formed into a thin film having a thickness of 40 μm or less, the moisture resistance and the heat resistance are improved sufficiently. In addition, color fading, deformation, and the like of the polarizer caused by outside moisture and the like are prevented, and thus the optical performance and the shape thereof become stable. Furthermore, the protection film can function as a supporting body of the polarizer.

Therefore, in a liquid crystal display device in which the polarizing plate of the present invention is employed, a reduction in image quality, which is caused by the reduction in optical performance and deformation of the polarizer, is prevented.

### BRIEF DESCRIPTION OF THE DRAWINGS

FIG. 1 is a schematic cross-sectional view of a liquid crystal display device to which a polarizing plate of the present invention is applied.

### DESCRIPTION OF THE REFERENCE NUMERALS

1 . . . liquid crystal panel, 2 and 10 . . . polarizer, 3 and 11 . . . protection film, 4 and 12 . . . polarizing plate, 9 . . . liquid crystal display device

### BEST MODE FOR CARRYING OUT THE INVENTION

The polarizing plate of the present invention has a protection film formed on at least one side of a polarizer. This protection film is formed by curing, with energy rays such as ultraviolet rays or electron rays, an energy ray-curable composition containing an energy ray-polymerizable compound (1) and a hydrolysate (2) of a silane-based coupling agent. The energy ray-polymerizable compound (1) is selected from at least one of a compound (1-a) having a bridged hydrocarbon group, a compound (1-b) having a bisphenol group, a compound (1-c) having a neopentyl glycol group, a compound (1-d) having a trimethylolpropane group, and a compound (1-e) having a pentaerythritol group. Using the specific energy ray-polymerizable compound mentioned above can prevent the occurrence of a reduction of optical performance such as color fading in the polarizing plate.

In the compound (1-a) having a bridged hydrocarbon group and serving as the energy ray-polymerizable compound (1), preferred examples of the bridged hydrocarbon group include a dicyclopentanyl group and a dicyclopentenyl group. In addition, the examples include an isobornyl group.

Examples of the main portion contributing to the polymerization of the energy ray-polymerizable compound having the bridged hydrocarbon group include a (meth)acroyl group including an acroyl group or a methacroyl group as a part thereof. In addition to this, the (meth)acroyl group (CH₂═CRCO—, wherein R is hydrogen or a methyl group) may be bonded to the bridged hydrocarbon group with oxygen (—O—) interposed therebetween (i.e. the (meth)acroyl group may be bonded to the bridged hydrocarbon group as a (meth)acroyloxy group). Moreover, the (meth)acroyl group may be bonded to the bridged hydrocarbon group with an oxyalkyleneoxy group (—O(CH₂)ₙO— or —O(CH₂)ₘO—, wherein n and m are each an integer of 1 to 10) interposed therebetween. Furthermore, the (meth)acroyl group may be bonded to the bridged hydrocarbon group with an EO (ethylene oxide)-modified group, a PO (propylene oxide)-modified group, an epoxy-modified group, or a modified group of a combination thereof interposed therebetween. For example, the (meth)acroyl group may be bonded to the bridged hydrocarbon group with —O(CH₂CH₂O)ₙ—, —O(CH(CH₃)CH₂O)ₙ—, —O(CH₂CH₂O)ₘ—, or —O(CH (CH₃)CH₂O)ₘ—interposed therebetween, wherein n and m are each an integer of 1 to 10.

Therefore, examples of the structural formula of the energy ray-polymerizable compound having the bridged hydrocarbon group include the following formulae (1) to (3):

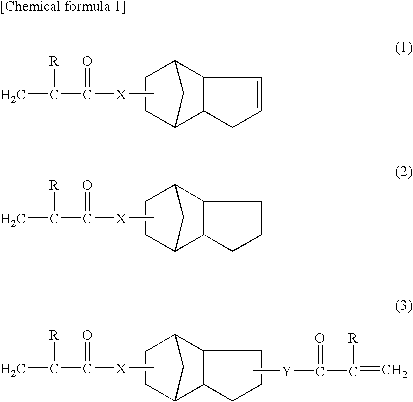

wherein, in the formulae (1) to (3), R is a hydrogen atom or a methyl group, X is —O—, —O(CH₂)ₙO—, —O(CH₂CH₂O)ₙ—, or —O(CH(CH₃)CH₂O)ₙ—, Y is —O—, —O(CH₂)ₘO—, —O(CH₂CH₂O)ₘ—, or —O(CH(CH₃)CH₂O)ₘ—, and n and m are each an integer of 1 to 10.

Specific examples of the energy ray-polymerizable compound having the bridged hydrocarbon group include dicyclopentanyl acrylate (FA-513A, Hitachi Chemical Co., Ltd.), dicyclopentanyl methacrylate (FA-513M, Hitachi Chemical Co., Ltd.), dicyclopentenyl acrylate (FA-511A, Hitachi Chemical Co., Ltd.), dicyclopentenyl oxyethyl acrylate (FA-512A, Hitachi Chemical Co., Ltd.), and dicyclopentenyl oxyethyl methacrylate (FA-512M, Hitachi Chemical Co., Ltd.).

In the compound (1-b) having a bisphenol group and serving as the energy ray-polymerizable compound (1), the bisphenol group is represented by the following formula:

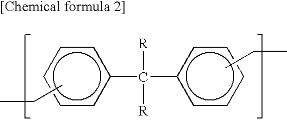

Preferred examples of the bisphenol group include a bisphenol A type group and a bisphenol F type group.

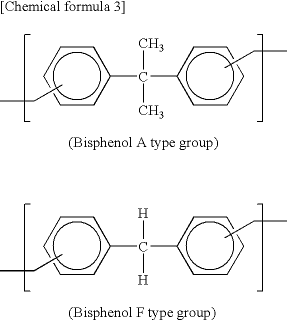

As in the above-described energy ray-polymerizable compound (1-a) having the bridged hydrocarbon group, examples of the main portion contributing to the polymerization of the energy ray-polymerizable compound having the bisphenol group include a (meth)acroyl group including an acroyl group or a methacroyl group as a part thereof. Furthermore, the (meth)acroyl group (CH₂═CRCO—, wherein R is hydrogen or a methyl group) may be bonded to the bisphenol group with oxygen (—O—) interposed therebetween (i.e. the (meth)acroyl group may be bonded to the bisphenol group as a (meth)acroyloxy group). Moreover, when the (meth)acroyl group is bonded to the bisphenol group, an EO (ethylene oxide)-modified group, a PO (propylene oxide)-modified group, an epoxy-modified group, or a modified group of a combination thereof may be introduced between these groups. For example, the (meth)acroyl group may be bonded to the bisphenol group with —O(CH₂CH₂O)ₙ—, —O(CH(CH₃)CH₂O)ₙ—, —O(CH₂CH₂O)ₘ—, or —O(CH(CH₃)CH₂O)ₘ— interposed therebetween. Here, n and m are each an integer of 1 to 10.

Therefore, examples of the structural formula of the energy ray-polymerizable compound having the bisphenol group include the following formulae (4) and (5):

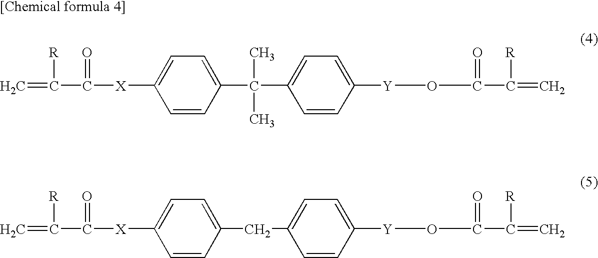

wherein, in the formulae (4) and (5), R is a hydrogen atom or a methyl group, X is —O—, —O(CH₂CH₂O)ₙ—, or —O(CH(CH₃)CH₂O)ₙ—, Y is —O—, —O(CH₂CH₂O)ₘ—, or —O(CH(CH₃)CH₂O)ₘ—, and n and m are each an integer of 1 to 10.

Specific examples of the energy ray-polymerizable compound having the bisphenol group include EO-modified bisphenol A diacrylate (SR-349, Sartomer Company Inc.; R-551, Nippon Kayaku Co., Ltd.), EO-modified bisphenol F diacrylate (R-712, Nippon Kayaku Co., Ltd.) epoxy-modified bisphenol A dimethacrylate (Epoxyester 3002M, KYOEISHA CHEMICAL Co., LTD.), epoxy-modified bisphenol A acrylate (Epoxyester 3002A, KYOEISHA CHEMICAL Co., LTD.), diglycidyl ether-modified bisphenol A dimethacrylate (Epoxyether 3000M, KYOEISHA CHEMICAL Co., LTD.), and diglycidyl ether-modified bisphenol A diacrylate (Epoxyester 3000A, KYOEISHA CHEMICAL Co., LTD.).

In the compound (1-c) having a neopentyl glycol group and serving as the energy ray-polymerizable compound (1), the neopentyl glycol group is represented by the following formula (6):

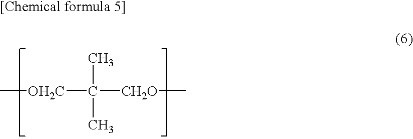

In the compound (1-d) having a trimethylolpropane group and serving as the energy ray-polymerizable compound (1), the trimethylolpropane group is represented by the following formula (7):

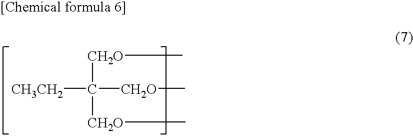

In the compound (1-e) having a pentaerythritol group and serving as the energy ray-polymerizable compound (1), the pentaerythritol group is represented by the following formula (8):

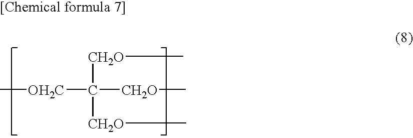

As in the above-described energy ray-polymerizable compound (1-a) having the bridged hydrocarbon group, examples of the main portion contributing to the polymerization of the energy ray-polymerizable compounds (1-c) to (1-e) include a (meth)acroyl group including an acroyl group or a methacroyl group as a part thereof. Furthermore, the (meth)acroyl group (CH₂═CRCO—, wherein R is hydrogen or a methyl group) may be bonded to the neopentyl glycol group, the trimethylolpropane group, or the pentaerythritol group with oxygen (—O—) interposed therebetween (i.e. the (meth)acroyl group may be bonded as a (meth)acroyloxy group). Moreover, the (meth)acroyl group may be bonded to the above groups with an oxyalkyleneoxy group (—O(CH₂)ₙO— or —O(CH₂)ₘO—, wherein n and m are each an integer of 1 to 10) interposed therebetween. Furthermore, the (meth)acroyl group may be bonded to the above groups with an EO (ethylene oxide)-modified group, a PO (propylene oxide)-modified group, an epoxy-modified group, or a modified group of a combination thereof interposed therebetween. For example, the (meth)acroyl group may be bonded to the neopentyl glycol group, the trimethylolpropane group, or the pentaerythritol group with —O(CH₂CH₂O)ₙ—, —O(CH(CH₃)CH₂O)ₙ—, —O(CH₂CH₂O)ₘ—, or —O(CH(CH₃)CH₂O)ₘ— interposed therebetween. Here, n and m are each an integer of 1 to 10.

Preferred examples of the energy ray-polymerizable compound (1-c) having the neopentyl glycol group include the following formulae (9) to (11):

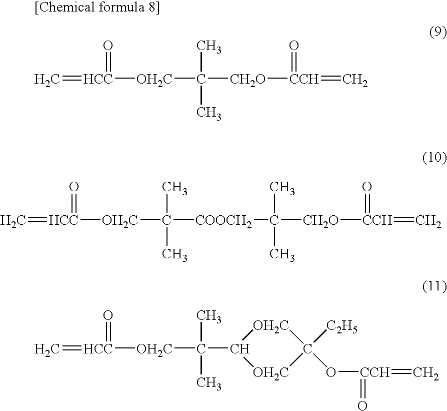

Preferred examples of the energy ray-polymerizable compound (1-d) having the trimethylolpropane group include the following formulae (12) and (13):

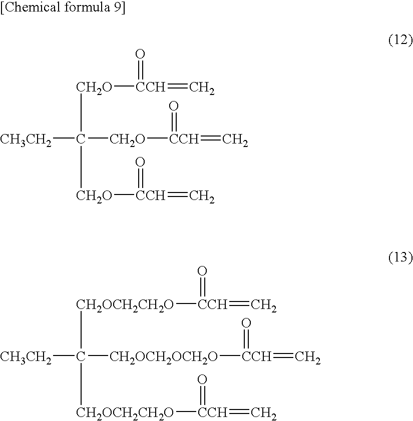

Preferred examples of the energy ray-polymerizable compound (1-e) having the pentaerythritol group include the following formulae (14) and (15):

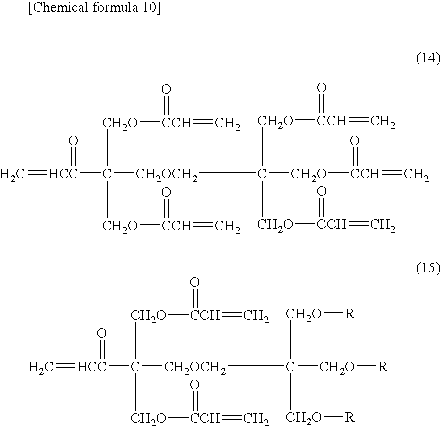

In the present invention, as the energy ray-polymerizable compound, one compound selected from among the compounds (1-a) to (1-e) above or a combination of two or more thereof may be used.

In the present invention, the energy ray-curable composition may contain, in addition to the abovementioned energy ray-polymerizable compounds (1-a) to (1-e), an additional energy ray-polymerizable compound in accordance with need. Examples of the additional energy ray-polymerizable compound include ethylenic unsaturated monomers. Specific examples include methyl(meth)acrylate, ethyl(meth)acrylate, propyl(meth)acrylate, n-butyl(meth)acrylate, t-butyl(meth)acrylate, 2-ethylhexyl(meth)acrylate, n-nonyl(meth)acrylate, cyclohexyl(meth)acrylate, benzyl(meth)acrylate, methoxyethyl(meth)acrylate, ethoxyethyl(meth)acrylate, butoxyethyl(meth)acrylate, methoxyethoxyethyl(meth)acrylate, ethoxyethoxyethyl(meth)acrylate, tetrahydrofurfuryl(meth)acrylate, carbitol acrylate, benzyl acrylate, allyl acrylate, phenoxyethyl acrylate, styrene, vinyltoluene, chlorostyrene, α-methylstyrene, acrylonitrile, vinyl acetate, N-vinylpyrrolidone, acryloxyethyl phosphate, 2-vinylpyridine, 2-ethylhexyl acrylate, 2-hydroxyethyl(meth)acrylate, 2-hydroxypropyl acrylate, ethylcarbitol acrylate, polypropylene glycol diacrylate, polyethylene glycol (#200, #400, #600) diacrylate, 2-hydroxy-3-phenoxypropyl acrylate, 2-acryloyloxyethyl succinic acid, 1,6-hexanediol diacrylate, methyltriglycol, acryloylmorpholine, 1,9-nonanediol diacrylate, and 2-n-butyl-2-ethyl-1,3-propanediol diacrylate. The oligomers of the above monomers may also be used. In addition to this, urethane(meth)acrylate, polybutadiene(meth)acrylate, isoprene acrylate, epoxy acrylate, and the like may also be used.

In order to polymerize and cure the energy-ray curable composition, the energy ray-polymerizable compound selected from the above compounds (1-a) to (1-e) is preferably used. Furthermore, when the energy ray-polymerizable compound selected from the above compounds (1-a) to (1-e) is used together with additional energy ray-polymerizable compounds other than the above compounds (1-a) to (1-e), it is preferable that a multifunctional group compound (for example, a compound having 2 or more (meth)acroyl groups in one molecule) be used as any of the additional energy ray-polymerizable compounds other than the compounds (1-a) to (1-e).

When the energy ray-polymerizable compound selected from the above compounds (1-a) to (1-e) is used together with an additional energy ray-polymerizable compound other than the above compounds (1-a) to (1-e), the use amount of the additional energy ray-polymerizable compound other than the compounds (1-a) to (1-e) depends on the type thereof and is preferably 80% by weight or less in the energy ray-curable composition and more preferably 40% by weight or less. When the amount is too large, the relative amount of the energy ray-polymerizable compound selected from among the compounds (1-a) to (1-e) decreases excessively, and thus there is a fear that the effect of the present invention is not obtained.

Meanwhile, as the hydrolysate of the silane-based coupling agent (2) added to the energy ray-curable composition, a hydrolysate of a silane compound of the following formula (16) may be used:

[Chemical formula 11]

R¹ₐOSi(OR²)₄₋ₐ (16)

In the above formula, R¹ represents an alkyl group having 1 to 10 carbon atoms, an alkenyl group, a (meth)acryloxy group, or an organic group having an amino group or a mercapto group. Examples of the alkyl group include a methyl group, an ethyl group, a propyl group, an isopropyl group, a butyl group, a hexyl group, a decyl group, and a cyclohexyl group. Examples of the alkenyl group include a vinyl group, a styryl group, an aryl group, a 9-decenyl group, and a p-vinylbenzyl group. Examples of the organic group having a (meth)acryloxy group include a γ-methacryloxypropyl group and a γ-acryloxypropyl group. Examples of the organic group having an amino group include a γ-aminopropyl group and a (β-aminoethyl)-γ-aminopropyl group. Examples of the organic group having a mercapto group include a γ-mercaptopropyl group and p-mercaptomethylphenylethyl group. Of these, the organic group having a vinyl group, a styryl group, a methacryloxy group, an acryloxy group, an amino group, or a mercapto group is preferred in terms of improving adhesion properties.

R² represents a hydrogen atom, an alkyl group having 1 to 10 carbon atoms, an alkenyl group, an aryl group, an alkoxyalkyl group, or an acyl group. Examples thereof include a methyl group, an ethyl group, a propyl group, an isopropyl group, a butyl group, a hexyl group, a phenyl group, an isopropenyl group, a methoxyethyl group, and an acetyl group.

The letter “a” represents an integer of 1 to 3.

Specific examples of the coupling agent of the formula (16) with a=3 include: alkenyl group-containing coupling agents such as vinyltrimethoxysilane, vinyltriethoxysilane, vinyltriacetoxysilane, vinyl-tris(2-methoxyethoxy)silane, vinyltriisopropenoxysilane, and p-styryltrimethoxysilane; methacryloxy group-containing coupling agents such as γ-methacryloxypropyltrimethoxysilane and γ-methacryloxypropyltriethoxysilane; acryloxy group-containing coupling agents such as γ-acryloxypropyltrimethoxysilane and γ-acryloxypropyltriethoxysilane; amino group-containing coupling agents such as γ-aminopropyltrimethoxysilane, γ-aminopropyltriethoxysilane, and N-(β-aminoethyl)-γ-aminopropyltrimethoxysilane; and mercapto group-containing coupling agents such as γ-mercaptopropyltrimethoxysilane and γ-mercaptopropyltriethoxysilane.

Specific examples of the coupling agent of the formula (16) with a=2 include: alkenyl group-containing coupling agents such as vinylmethyldimethoxysilane, vinylmethyldiethoxysilane, vinylmethyldiacetoxysilane, vinylmethyldi(2-methoxyethoxy)silane, and vinylmethyldiisopropenoxysilane; methacryloxy group-containing coupling agents such as γ-methacryloxypropylmethyldimethoxysilane; acryloxy group-containing coupling agents such as γ-acryloxypropylmethyldimethoxysilane; amino group-containing coupling agents such as γ-aminopropylmethyldimethoxysilane and γ-aminopropylmethyldiethoxysilane; and mercapto group-containing coupling agents such as γ-mercaptopropylmethyldimethoxysilane and γ-mercaptopropylmethyldiethoxysilane.

These silane compounds may be used alone or as a mixture of two or more.

Of these silane compounds, trialkoxysilane or dialkoxysilane is preferred. Meanwhile, tetraalkoxysilane does not have a functional group such as an alkenyl group, a methacryloxy group, or an acryloxy group. Hence, tetraalkoxysilane does not function as a coupling agent and thus does not serve as the silane-based coupling agent used as a hydrolysate in the present invention.

Preferably, the hydrolysis of the silane-based coupling agent is preformed using aqueous boric acid. The hydrolysis using aqueous boric acid can significantly improve the adhesion properties of a protection film against an optical device. Conversely, for example, when a hydrolysate prepared by hydrolyzing the silane coupling agent with acetic acid is used, the adhesion properties of a protection film cannot be sufficiently improved. Therefore, it is difficult to solve a problem of color fading caused by outside moisture or the like. Although the adhesion properties of a protection film can be improved using aqueous boric acid for hydrolyzing the silane-based coupling agent, the reason of the improvement is not clear. However, the improvement is considered to be related to the fact that a polarizer is formed using aqueous boric acid as described later.

A clear liquid-like treated solution is obtained by mixing the silane-based coupling agent and aqueous boric acid and allowing them to react at 20 to 80° C. for 1 to 12 hours, and in particular, for 3 to 8 hours. Preferably, as the hydrolysate of the silane-based coupling agent which is used for preparing the energy ray-curable composition, the as-obtained treated solution is used without further treatment. An excessively long reaction time for the hydrolysis is not preferred. This is because the condensation of the hydrolysate proceeds and the hydrolysate is polymerized, whereby a precipitate is formed. Hence, the adhesion properties of the protection film cannot be sufficiently improved.

In order to suppress the residual amount of water after hydrolysis as low as possible, the amount of water in aqueous boric acid used for hydrolyzing the silane-based coupling agent is preferably 0.5 to 3 eq. with respect to the silane-based coupling agent. For example, in the case of trialkoxysilane shown below which has three reactive sites, one equivalent of water with respect to 1 mole of the silane-based coupling agent is 3 moles.

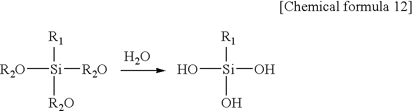

When the amount of water is too large, water is separated in the energy ray-curable composition, and thus the transparency after polymerization is reduced, which is not preferable.

In terms of adhesion properties and moisture resistance, the boric acid concentration in aqueous boric acid used for hydrolysis is preferably 1 to 5% by weight.

The preferable pH during hydrolysis depends on the type of the silane-based coupling agent. For example, when γ-acryloxypropyltrimethoxysilane is used as the silane-based coupling agent, the pH is preferably 4 to 4.5.

When the energy ray-curable composition is prepared, the mixing ratio of the hydrolysate of the silane-based coupling agent to the abovementioned energy ray-polymerizable compound is preferably 1 to 20 parts by weight of the hydrolysate of the silane-based coupling agent with respect to 100 parts by weight of the energy ray-polymerizable compound. When the use amount of the hydrolysate of the silane-based coupling agent is too low, the moisture resistance cannot be sufficiently improved. When the amount is too large, the moisture resistance deteriorates.

In the present invention, an energy ray polymerization initiator may be added to the energy ray-curable composition. The energy ray polymerization initiator may be appropriately selected, depending on the type of energy rays, from, for example, cobalt octenoate, cobalt naphthenate, manganese octenoate, manganese naphthenate, methyl ethyl ketone peroxide, cyclohexanone peroxide, cumene hydroperoxide, benzoyl peroxide, dicumyl peroxide, t-butyl perbenzoate, benzoin, benzoin methyl ether, benzoin ethyl ether, benzoin isopropyl ether, benzoin-n-butyl ether, benzoin phenyl ether, anthraquinone, naphthoquinone, pivaloin ethyl ether, benzyl ketal, 1,1-dichloroacetophenone, p-t-butyldichloroacetophenone, 2-chlorothioxanthone, 2,2-diethoxyacetophenone, Michler's ketone, 2,2-dichloro-4-phenoxyacetophenone, 2,2-dimethoxy-2-phenylacetophenone, benzophenone, 2-methylthioxanthone, phenylglyoxylate, α-hydroxyisobutylphenone, dibenzosuberone, benzophenone-amines (such as N-methyldiethanol and triethylamine), benzyldiphenyldisulfide, tetramethylthiuram monosulfite, azobisisobutyronitrile, dibenzyl, diacetyl, acetophenone, 2,2-dimethoxy-2-phenylacetophenone, 2-methyl-[4-(methylthio)phenyl]-2-morpholino-1-propanone, 1-hydroxycyclohexyl phenyl ketone, 2-hydroxy-2-methyl-1-phenylpropane-1-one methyl benzoylformate, and the like.

No particular limitation is imposed on the mixed amount of the energy ray polymerization initiator. However, the amount thereof is preferably 0.1 to 15 parts by weight, and more preferably 0.5 to 10 parts by weight with respect to 100 parts by weight of the total resin solid content of the above energy ray-polymerizable compounds (1-a) to (1-e) and the additional energy ray-polymerizable compound.

An organic solvent may be added to the energy ray-curable composition in accordance with need. Examples of the organic solvent include: ketone-based solvents such as acetone, methyl ethyl ketone, and cyclohexanone; ester-based solvents such as methyl acetate, ethyl acetate, butyl acetate, ethyl lactate, methoxyethyl acetate, propylene glycol monomethyl ether acetate, and ethylene glycol diacetate; ether-based solvents such as diethyl ether, ethylene glycol dimethyl ether, and dioxane; aromatic solvents such as toluene and xylene; aliphatic-based solvents such as pentane and hexane; halogen-based solvents such as methylene chloride, chlorobenzene, and chloroform; and alcohol-based solvents such as isopropyl alcohol and butanol.

To the energy ray-curable composition, additives such as a pigment, a filler, a leveling agent, an antifoaming agent, and a thermoplastic resin may be further added in accordance with need.

In the present invention, a protection film may be formed as follows. The energy ray-curable composition is obtained by mixing the above-described components. The obtained energy ray-curable composition is applied to at least one side of a polarizer, described later, by means of a known coating method such as a curtain-coating method, a roll-coating method, a flow-coating method, a spray-coating method, or a dip-coating method. If necessary, the organic solvent is vaporized and removed at 40 to 100° C. Thereafter, the energy ray-curable composition is cured by applying energy rays such as electron rays, proton rays, neutron rays, or electromagnetic waves such as far-ultraviolet rays, ultraviolet rays, near-ultraviolet rays, X-rays, or γ-rays. Of these, ultraviolet rays are advantageously used as the energy rays, in terms of the film-forming (curing) rate, the availability and cost of an energy ray-irradiation apparatus, and the like. Here, ultraviolet rays are composed mainly of rays in a wavelength range of 150 to 450 nm and can be generated by chemical lamps, high-pressure mercury lamps, metal halide lamps, xenon lamps, and the like.

No particular limitation is imposed on the thickness of the protection film. However, the thickness is preferably 40 μm or less, and more preferably 25 μm or less in terms of a reduction in thickness of the film. Moreover, the thickness is preferably 5 μm or more in terms of preventing color fading.

The protection film may by formed not only by directly applying the energy ray-curable composition to a polarizer but also by applying the composition to a release sheet, projecting energy rays thereonto to form a film, and applying the film to a polarizer with a known adhesive or paste.

Meanwhile, no particular limitation is imposed on the polarizer in the polarizing plate of the present invention, and any conventionally known polarizer may be employed. In particular, a uniaxially stretched film made of a polyvinyl alcohol-based resin and stained with iodine can be preferably employed.

A polyvinyl alcohol-based resin is generally produced by saponifying polyvinyl acetate prepared by polymerizing vinyl acetate, but the present invention is not necessarily limited thereto. The polyvinyl alcohol-based resin may contain a small amount of a component which is copolymerizable with vinyl acetate. Examples of such a component include unsaturated carboxylic acids (including their salts, esters, amides, nitrites, and the like), olefins, vinyl ethers, and unsaturated sulfonic acid salts. Practically, the average degree of saponification of the polyvinyl alcohol-based resin is preferably 85 to 100 mol %, and more preferably 98 to 100 mol %. Moreover, a polyvinyl alcohol-based resin having any average degree of polymerization can be used.

As a specific method for manufacturing the polarizer, any known method may be employed. Examples of the manufacturing method include the following. A polyvinyl alcohol-based resin is dissolved in water, an organic solvent (such as DMSO, a polyalcohol such as glycerin, or an amine such as ethylenediamine), or a mixed solvent of water and the organic solvent (the amount of water: about 5 to about 30% by weight) to thereby prepare a raw solution containing about 5 to about 20% by weight of the resin. Then, the raw solution is formed into a film. Thereafter, the film is (a) stretched, then stained by immersing in an iodine solution or a dichromatic dye solution, and thereafter treated with a boron compound, (b) stretched and stained at the same time by stretching the film while the film is immersed in an iodine solution or a dichromatic dye solution, and then treated with a boron compound, (c) stained by immersing in an iodine solution or a dichromatic dye solution, then stretched, and thereafter treated with a boron compound, or (d) stained by immersing in an iodine solution or a dichromatic dye solution and then stretched in a boron compound solution.

As a method for forming a film of the polyvinyl alcohol-based resin, any known method such as a casting method, an extrusion method, or a gel film formation method may be employed.

Moreover, it is desirable that the formed film of the polyvinyl alcohol-based resin be stretched once or a plurality of times in a uniaxial direction preferably at a temperature of 40 to 170° C. so as to be finally stretched by 3 to 10 times, and preferably by 3.5 to 6 times. At this time, the film may also be stretched slightly in the direction perpendicular to the above uniaxial direction (to the extent that the shrinkage in the width direction is prevented or to a larger extent).

The formed film of the polyvinyl alcohol-based resin may be stained by bringing the film into contact with an iodine solution or a dichromatic dye-containing solution. Normally, an aqueous solution of iodine-potassium iodide is used. An appropriate concentration of iodine is 0.1 to 2 g/L, and an appropriate concentration of potassium iodide is 10 to 50 g/L. Further, an appropriate weight ratio of iodine to potassium iodide is 20 to 100. Practically, the staining time is approximately 30 to approximately 500 seconds. Preferably, the temperature of a staining bath is 5 to 50° C. In addition to water, a small amount of an organic solvent compatible with water may be added. As contacting means, any means such as immersion, application, and spraying can be applied.

The polyvinyl alcohol-based resin film having been subjected to staining treatment is then subjected to treatment with a boron compound. Specifically, the polyvinyl alcohol-based resin film may be brought into contact with an aqueous solution of a boron compound such as boric acid or borax or with a water-containing organic solvent (approximately 0.5 to approximately 2 mol/L) at a temperature of 50 to 70° C. in the presence of a small amount of potassium iodide by means of immersion, application, or spraying. If necessary, the stretching operation of the film may be performed while the film is treated with a boron compound.

The polarizing plate of the present invention may be manufactured by forming the protection film on at least one side of the polarizer, as described above.

A conventional TAC film may be applied to one or both sides of the polarizing plate of the present invention with an adhesive within the range which does not impair the effect of the present invention. If necessary, a known transparent pressure-sensitive adhesive layer may be provided by means of a routine method.

A particularly preferred pressure-sensitive adhesive layer is composed mainly of a copolymer of an acrylate such as butyl acrylate, ethyl acrylate, methyl acrylate, or 2-ethylhexyl acrylate with an α-mono-olefin carboxylic acid such as acrylic acid, maleic acid, itaconic acid, methacrylic acid, or crotonic acid (the copolymer may contain a vinyl monomer such as acrylonitrile, vinyl acetate, or styrol). This is because such a layer does not interfere the polarizing characteristics of the polarizer. In addition, a transparent paste such as a polyvinyl ether-based or rubber-based adhesive may be used.

The polarizing plate of the present invention may be stacked with one or more functional layers, such as an antiglare layer, a hard-coated layer, an antireflection layer, a half-reflection layer, a reflection layer, a light storage layer, a light diffusion layer, and an electroluminescent layer, with an adhesive or a paste.

The polarizing plate of the present invention can be preferably employed as a polarizing plate which is to be applied to at least one side of a display panel such as a liquid crystal panel and an organic EL panel having a conventionally known structure or as a polarizing plate which is to be applied to at least one side of a lens for eyeglasses such as sunglasses and glasses for vision correction.

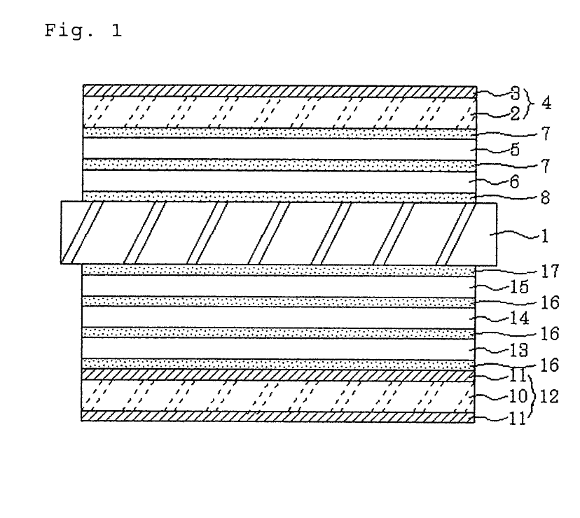

For example, as shown in FIG. 1, a polarizing plate 4 composed of a polarizer 2 and a protection film 3 is stacked with a λ/2 retardation film 5 and a λ/4 retardation film 6 with adhesive layers 7 interposed therebetween, respectively, with the films and layers stacked on the side opposite to the protection film 3. The entire stacked body is pasted on one side of a liquid crystal panel 1 by means of an adhesive layer 8. Meanwhile, a polarizing plate 12 is formed by providing a protection film 11 on both sides of a polarizer 10. Then, a λ/2 retardation film 13, a λ/4 retardation film 14, and a viewing angle improving film 15 are stacked on one side of the polarizing plate 12 by means of an adhesive layer 16. The entire stacked body is pasted on the other side of the liquid crystal panel 1 by means of an adhesive layer 17. In this manner, a liquid crystal display device 9 having the polarizing plates with a reduced thickness is obtained.

### EXAMPLES

Hereinafter, the present invention is specifically described by way of Examples.

### Examples 1 to 16 and Comparative Examples 1 and 2

### (1) Manufacturing of Polarizer

A polyvinyl alcohol film having a saponification degree of 99.5 mol % (thickness: 75 μm) was immersed in pure water and was allowed to swell sufficiently. Subsequently, the polyvinyl alcohol film was stained by immersing in an iodine staining solution (iodine/potassium iodide/boric acid/pure water=0.2 g/30 g/30 g/1 L) at 35° C. for 4 minutes. The stained polyvinyl alcohol film was uniaxially stretched by 5 times or more in a stretching solution (potassium iodide/boric acid/pure water=30 g/30 g/l L). The stretched polyvinyl alcohol film was immersed in a fixing solution (potassium iodide/boric acid/pure water=40 g/40 g/l L) at 40° C. for 3 minutes to thereby fix iodine in the polyvinyl alcohol film. Subsequently, the film was removed from the fixing solution and dried in a drying furnace (65° C. for 5 minutes) to thereby produce a polarizer.

### (2) Formation of Protection Films

Each of silane-based coupling agents shown in Table 1 was hydrolyzed with an equivalent amount of water at 60° C. for 6 hours by using 3% aqueous boric acid. The hydrolyzed coupling agent was mixed with a corresponding energy ray-polymerizable compound, and the mixture was stirred, thereby preparing each energy ray-curable composition.

Each of the energy ray-curable compositions was applied to both sides of the polarizer obtained in (1) to a thickness of 20 μm. The coating was cured by projecting ultraviolet rays (wavelength: 365 nm) thereonto from a metal halide lamp until the integrated light quantity reached 400 mJ/cm², thereby obtaining a polarizing plate having a protection film formed on both the sides of the polarizer.

### (3) Evaluation

### (3-1) Changes in Light Transmittance and Polarization Degree

An aging test was performed. Specifically, each of the polarizing plates was left to stand in an environment of 60° C. and a moisture of 90% RH for 250 hours. Before and after the aging test, an average light transmittance in a wavelength range of 400 to 700 nm was measured by means of a spectrophotometer, and a polarization degree was measured by means of a retardation measurement system (RETS-1100, product of OTSUKA ELECTRONICS CO., LTD.). The rate of change in light transmittance after aging to before aging was determined, and the difference in polymerization degree before and after aging was determined. These were judged as good when the value was less than 10% and were judged as poor when the value was 10% or more. The results are shown in Table 1.

### (3-2) Appearance

After the aging test in (3-1), the appearance of each of the polarizing plates was observed, and the presence or absence of color fading was determined. When color fading was present, the region having color fading was measured for the spreading size from an edge portion of the polarizing plate. A polarizing plate having no color fading was judged as good. A polarizing plate having a color fading region with a size of less than 0.5 mm was judged as normal, and a polarizing plate having a color fading region with a size of 0.5 mm or more or having a peeled protection film was judged as poor. The results are shown in Table 1.

### (3-3) Evaluation of Adhesion Properties

A cross cut test was performed according to JIS K5400. Specifically, a grid of cuts at horizontal and vertical intervals of 1 mm was formed on each of the protection films by means of a cutter, and the condition of the cuts was rated from 0 to 10 according to the criteria of JIS K5400. The results are shown in Table 1.

TABLE 1

| Composition of curable composition (parts by | | | | | | |
|---|---|---|---|---|---|---|
| weight) | | Ex. 1 | Ex. 2 | Ex. 3 | Ex. 4 | Ex. 5 |
| Polymerizable | EO-modified bisphenol A | 100 | 100 | 100 | 100 | 100 |
| compound | diacrylate (*1) | | | | | |
| | Hydroxypivalic acid | | | | | |
| | neopentyl glycol | | | | | |
| | diacetate (*2) | | | | | |
| | Trimethylolpropane | | | | | |
| | triacetate (*3) | | | | | |
| | Dipentaerythritol | | | | | |
| | hexaacetate (*4) | | | | | |
| Hydrolysate of | Hydrolysate of | 5 | | | | |
| coupling agent | vinyltriethoxysilane (*5) | | | | | |
| | Hydrolysate of p- | | 5 | | | |
| | styryltrimethoxysilane (*6) | | | | | |
| | Hydrolysate of γ- | | | 5 | | |
| | methacryloxypropyl | | | | | |
| | trimethoxysilane (*7) | | | | | |
| | Hydrolysate of γ- | | | | 5 | |
| | aminopropyl | | | | | |
| | triethoxysilane (*8) | | | | | |
| | Hydrolysate of γ- | | | | | 5 |
| | mercaptopropyl | | | | | |
| | trimethoxysilane (*9) | | | | | |
| | Hydrolysate of γ- | | | | | |
| | acryloxypropyl | | | | | |
| | trimethoxysilane (*10) | | | | | |
| | γ-acryloxypropyl | | | | | |
| | trimethoxysilane (*10), | | | | | |
| | (not hydrolyzed) | | | | | |
| Initiator | 2-hydroxy-2-methyl-1- | 5 | 5 | 5 | 5 | 5 |
| | phenylpropane-1-one (*11) | | | | | |

Evaluation

| Transmittance | Before aging test | 40.59 | 38.82 | 40.74 | 40.28 | 40.78 |
|---|---|---|---|---|---|---|
| | After aging test | 42.51 | 41.08 | 41.38 | 40.75 | 40.28 |
| | Rate of change (%) | 4.74 | 5.84 | 1.56 | 1.16 | −1.22 |
| | Judgment | good | good | good | good | good |
| Polarization | Before aging test | 99.96 | 99.96 | 99.97 | 99.97 | 99.97 |
| degree | | | | | | |
| | After aging test | 99.91 | 99.96 | 99.92 | 99.91 | 99.96 |
| | Rate of change (%) | 0.05 | 0.00 | 0.05 | 0.06 | 0.01 |
| | Judgment | good | good | good | good | good |
| Color fading | | none | none | none | none | none |
| | | good | good | good | good | good |
| Adhesion | | 10 | 10 | 10 | 10 | 10 |
| properties | | | | | | |
| Composition of curable composition (parts by | | | | | | |
| weight) | | Ex. 6 | Ex. 7 | Ex. 8 | Ex. 9 | Ex. 10 |
| Polymerizable | EO-modified bisphenol A | 100 | 100 | 100 | 100 | |
| compound | diacrylate (*1) | | | | | |
| | Hydroxypivalic acid | | | | | 100 |
| | neopentyl glycol | | | | | |
| | diacetate (*2) | | | | | |
| | Trimethylolpropane | | | | | |
| | triacetate (*3) | | | | | |
| | Dipentaerythritol | | | | | |
| | hexaacetate (*4) | | | | | |
| Hydrolysate of | Hydrolysate of | | | | | |
| coupling agent | vinyltriethoxysilane (*5) | | | | | |
| | Hydrolysate of p- | | | | | |
| | styryltrimethoxysilane (*6) | | | | | |
| | Hydrolysate of γ- | | | | | |
| | methacryloxypropyl | | | | | |
| | trimethoxysilane (*7) | | | | | |
| | Hydrolysate of γ- | | | | | |
| | aminopropyl | | | | | |
| | triethoxysilane (*8) | | | | | |
| | Hydrolysate of γ- | | | | | |
| | mercaptopropyl | | | | | |
| | trimethoxysilane (*9) | | | | | |
| | Hydrolysate of γ- | 5 | 20 | 10 | 1 | 5 |
| | acryloxypropyl | | | | | |
| | trimethoxysilane (*10) | | | | | |
| | γ-acryloxypropyl | | | | | |
| | trimethoxysilane (*10), | | | | | |
| | (not hydrolyzed) | | | | | |
| Initiator | 2-hydroxy-2-methyl-1- | 5 | 5 | 5 | 5 | 5 |
| | phenylpropane-1-one (*11) | | | | | |

Evaluation

| | | | | | | |
|---|---|---|---|---|---|---|
| Transmittance | Before aging test | 41.85 | 41.88 | 41.66 | 42.20 | 42.63 |
| | After aging test | 43.08 | 44.88 | 44.92 | 43.68 | 42.82 |
| | Rate of change (%) | 2.94 | 7.17 | 7.82 | 3.51 | 0.45 |
| | Judgment | good | good | good | good | good |
| Polarization | Before aging test | 99.91 | 99.89 | 99.91 | 99.93 | 99.93 |
| degree | | | | | | |
| | After aging test | 99.73 | 95.93 | 95.08 | 99.79 | 99.92 |
| | Rate of change (%) | 0.18 | 3.96 | 4.83 | 0.14 | 0.01 |
| | Judgment | good | good | good | good | good |
| Color fading | | none | none | none | none | none |
| | | good | good | good | good | good |
| Adhesion | | 10 | 10 | 10 | 6 | 10 |
| properties | | | | | | |

| Composition of curable composition (parts by | | | | | |
|---|---|---|---|---|---|
| weight) | | Ex. 11 | Ex. 12 | Ex. 13 | Ex. 14 |
| Polymerizable | EO-modified bisphenol A | 50 | | | |
| compound | diacrylate (*1) | | | | |
| | Hydroxypivalic acid | 50 | 50 | 30 | 50 |
| | neopentyl glycol | | | | |
| | diacetate (*2) | | | | |
| | Trimethylolpropane | | 50 | 70 | |
| | triacetate (*3) | | | | |
| | Dipentaerythritol | | | | 50 |
| | hexaacetate (*4) | | | | |
| Hydrolysate of | Hydrolysate of | | | | |
| coupling agent | vinyltriethoxysilane (*5) | | | | |
| | Hydrolysate of p- | | | | |
| | styryltrimethoxysilane (*6) | | | | |
| | Hydrolysate of γ- | | | | |
| | methacryloxypropyl | | | | |
| | trimethoxysilane (*7) | | | | |
| | Hydrolysate of γ- | | | | |
| | aminopropyl | | | | |
| | triethoxysilane (*8) | | | | |
| | Hydrolysate of γ- | | | | |
| | mercaptopropyl | | | | |
| | trimethoxysilane (*9) | | | | |
| | Hydrolysate of γ- | 5 | 5 | 5 | 5 |
| | acryloxypropyl | | | | |
| | trimethoxysilane (*10) | | | | |
| | γ-acryloxypropyl | | | | |
| | trimethoxysilane (*10), | | | | |
| | (not hydrolyzed) | | | | |
| Initiator | 2-hydroxy-2-methyl-1- | 5 | 5 | 5 | 5 |
| | phenylpropane-1-one (*11) | | | | |

Evaluation

| | | | | | |
|---|---|---|---|---|---|
| Transmittance | Before aging test | 42.12 | 42.23 | 41.56 | 41.82 |
| | After aging test | 43.56 | 43.21 | 42.34 | 43.34 |
| | Rate of change (%) | 3.42 | 2.32 | 1.88 | 3.63 |
| | Judgment | good | good | good | good |
| Polarization | Before aging test | 99.95 | 99.94 | 99.94 | 99.95 |
| degree | | | | | |
| | After aging test | 99.93 | 99.93 | 99.91 | 99.94 |
| | Rate of change (%) | 0.02 | 0.01 | 0.03 | 0.01 |
| | Judgment | good | good | good | good |
| Color fading | | none | none | none | none |
| | | good | good | good | good |
| Adhesion | | 10 | 10 | 10 | 10 |
| properties | | | | | |

| Composition of curable composition (parts by | | | | Comp. | Comp. |
|---|---|---|---|---|---|
| weight) | | Ex. 15 | Ex. 16 | Ex. 1 | Ex. 2 |
| Polymerizable | EO-modified bisphenol A | 100 | 100 | 100 | 100 |
| compound | diacrylate (*1) | | | | |
| | Hydroxypivalic acid | | | | |
| | neopentyl glycol | | | | |
| | diacetate (*2) | | | | |
| | Trimethylolpropane | | | | |
| | triacetate (*3) | | | | |
| | Dipentaerythritol | | | | |
| | hexaacetate (*4) | | | | |
| Hydrolysate of | Hydrolysate of | | | | |
| coupling agent | vinyltriethoxysilane (*5) | | | | |
| | Hydrolysate of p- | | | | |
| | styryltrimethoxysilane (*6) | | | | |
| | Hydrolysate of γ- | | | | |
| | methacryloxypropyl | | | | |
| | trimethoxysilane (*7) | | | | |
| | Hydrolysate of γ- | | | | |
| | aminopropyl | | | | |
| | triethoxysilane (*8) | | | | |
| | Hydrolysate of γ- | | | | |
| | mercaptopropyl | | | | |
| | trimethoxysilane (*9) | | | | |
| | Hydrolysate of γ- | 0.5 | 30 | | |
| | acryloxypropyl | | | | |
| | trimethoxysilane (*10) | | | | |
| | γ-acryloxypropyl | | | | 5 |
| | trimethoxysilane (*10), | | | | |
| | (not hydrolyzed) | | | | |
| Initiator | 2-hydroxy-2-methyl-1- | 5 | 5 | 5 | 5 |
| | phenylpropane-1-one (*11) | | | | |

Evaluation

| | | | | | |
|---|---|---|---|---|---|
| Transmittance | Before aging test | 41.90 | 42.41 | 41.97 | 41.52 |
| | After aging test | 43.57 | 47.67 | 56.34 | 43.08 |
| | Rate of change (%) | 3.99 | 12.40 | 34.24 | 3.76 |
| | Judgment | good | poor | poor | good |
| Polarization | Before aging test | 99.94 | 99.83 | 99.93 | 99.90 |
| degree | | | | | |
| | After aging test | 99.70 | 84.58 | 73.99 | 99.87 |
| | Rate of change (%) | 0.21 | 15.27 | 25.96 | 0.03 |
| | Judgment | good | poor | poor | good |
| Appearance, color | | 0.2 mm | none | Exfoliation | 0.6 mm |
| fading from edge | | normal | good | on one side | poor |
| portion | | | | poor | |
| Adhesion | | 4 | 10 | 0 | 4 |
| properties | | | | | |

Notes in Table
(*1) SR349, Sartomer Company Inc.
(*2) MANDA, Nippon Kayaku Co., Ltd.
(*3) KS-TMPTA, Nippon Kayaku Co., Ltd.
(*4) DPHA, Nippon Kayaku Co., Ltd.
(*5) KBM-1003, Shin-Etsu Chemical Co., Ltd.
(*6) KBM-1403, Shin-Etsu Chemical Co., Ltd.
(*7) KBM-503, Shin-Etsu Chemical Co., Ltd.
(*8) KBM-903, Shin-Etsu Chemical Co., Ltd.
(*9) KBM-803, Shin-Etsu Chemical Co., Ltd.
(*10) KBM-5103, Shin-Etsu Chemical Co., Ltd.
(*11) D1173, Ciba Specialty Chemicals

As can be seen from Table 1, it is preferable that the added amount of the hydrolysate of the silane-based coupling agent in the energy ray-curable composition be 1 to 20 parts by weight with respect to 100 parts by weight of the energy ray-polymerizable compound. In particular, when the amount is 1 to 5 parts by weight, color fading from edge portions can be suppressed while the deterioration of transmittance and polarization degree after the aging test is suppressed. Moreover, as can been seen, the effect of adding the hydrolysate of the silane-based coupling agent could be obtained even when the type of the coupling agent was changed, so long as particular polymerizable compounds were used (Examples 6, and 10 to 14).

Conversely, as can be seen, when an excessive amount of the hydrolysate of the silane-based coupling agent was added, the transmittance and polarization degree after the aging test tend to deteriorate (Example 16). Furthermore, when the hydrolysate of a silane-based coupling agent was not added, the adhesion properties of the protection film were extremely poor, and the protection film was peeled off during the manufacturing stage of the polarizing plate. Thus, the transmittance and polarization degree after the aging test deteriorated significantly (Comparative Example 1). Moreover, when the silane coupling agent was added without hydrolysis, color fading from edge portions occurred after the aging test, and the adhesion properties of the protection film were not improved (Comparative Example 2).

### INDUSTRIAL APPLICABILITY

In the polarizing plate of the present invention, although the thickness of the protection film is reduced, the polarizer is protected from the influence of outside moisture and the like, and thus good polarizing ability can be maintained even in an environment of high temperature and high humidity. Therefore, the polarizing plate is useful in liquid crystal display devices and other various optical devices which use the polarizing plate.

1. A polarizing plate comprising a polarizer and a protection film formed on at least one side of the polarizer by curing an energy ray-curable composition, wherein the energy ray-curable composition contains
(1) an energy ray-polymerizable compound having a bridged hydrocarbon group, a bisphenol group, a neopentyl glycol group, a trimethylolpropane group, or a pentaerythritol group and
(2) a hydrolysate of a silane-based coupling agent.

2. The polarizing plate according to claim 1, wherein the silane-based coupling agent comprises trialkoxysilane or dialkoxysilane.

3. The polarizing plate according to claim 1, wherein the hydrolysate of the silane-based coupling agent comprises a treated solution prepared by treating the silane-based coupling agent with aqueous boric acid.

4. The polarizing plate according to claim 3, wherein the hydrolysate of the silane-based coupling agent is a clear liquid prepared by treating the silane-based coupling agent with 0.5 to 3 equivalent of aqueous boric acid with respect to the silane-based coupling agent.

5. The polarizing plate according to claim 1, wherein the energy ray-polymerizable compound contains 1 to 20 parts by weight of the hydrolysate of the silane-based coupling agent with respect to 100 parts by weight of the energy ray-polymerizable compound.

6. A liquid crystal display device comprising a liquid crystal panel and the polarizing plate according to claim 1, the polarizing plate provided on at least one side of the liquid crystal panel.
